(19) United States
(12) Patent Application Publication
(10) Pub. No.: US 2019/0381933 A1
(43) Pub. Date: Dec. 19, 2019

(54) AUTOMOBILE DIGITAL DISPLAY SYSTEM

(71) Applicant: James Claybrooks, Chattanooga, TN (US)

(72) Inventor: James Claybrooks, Chattanooga, TN (US)

(21) Appl. No.: 16/429,354

(22) Filed: Jun. 3, 2019

Related U.S. Application Data
(60) Provisional application No. 62/684,797, filed on Jun. 14, 2018.

(51) Int. Cl. B60Q 1/50; B60R 11/02; G09F 9/33; G01S 17/02

(52) U.S. Cl. CPC B60Q 1/503; B60R 11/0229; B60R 2011/0026; G01S 17/026; G09F 9/33

(57) ABSTRACT

Embodiments are described for an automobile digital display system to provide a variety of sympathetic, kind, and heartfelt messages to a trailing vehicle using a releasably attached translucent display mounted along a portion of the rear-view window. The system includes a microprocessor and memory module with a plurality of pre-programmed messages which when selected on a remote-control assembly affixed along the dashboard provide uplifting and courtesy messages to following vehicles.

### PRIORITY

This utility application claims the benefit of U.S. Provisional Patent Application No. 62/684,797, filed on Jun. 14, 2018, the entirety of which is hereby incorporated by reference.

### FIELD OF THE INVENTION

The embodiments presented relate to an automobile display system, and in particular, to an automobile display system which provides a pre-programmed uplifting/sympathetic message to a trailing vehicle through a translucent display attached to the rear window of an automobile.

### BACKGROUND

Sign displays for vehicles so drivers or passengers can convey a message to other drivers have existed in the art and were traditionally comprised of plain stationary messages printed on an opaque display. Frequently, these signs took the form of bumper stickers affixed to the outside of the vehicle or window stickers and boards that can be affixed to the interior of the vehicle for other drivers to read through the windows. These signs were used to convey a single message that could not be altered or selectively displayed without completely removing or replacing the sign itself. Consequently, the messages conveyed were not responsive to the actions of other drivers but were representative of the driver and passengers such as conveying that a baby was in the vehicle or the driver's political or social views and affiliations.

Many devices and apparatus are known in the field of art which provide a variety of digital display and messaging in connection with advertising and marketing in both commercial and recreational settings to promote business, commerce, and special events.

Digital display messaging has been incorporated into various vehicle and mobile display ads and provides commercial value by advertising different promotions and messages to a variety of businesses.

U.S. Pat. No. 5,825,281 provides a method of displaying advertising messages to offer greeting and safety messages to drivers. The method indicates that when the driver depresses the brake pedal the displayed message is changed which is shown out of the rear window of the vehicle.

U.S. Pat. No. 6,060,993 provides a vehicle-mounted digital display for commercial advertising including wireless communication and GPS system to enable messaging on the digital display originating from a designated headquarters. Further, the '993 patent utilizes a GPS system transceiver to promote local business along the transit route.

With the aforementioned limitations, improvements in the arts related to fire starters is warranted as a self-igniting starter is both useful and desirable to consumers. The following disclosure provides embodiments having such improvements.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a perspective view of the automobile digital display system, according to an embodiment of the present invention;

FIG. 2 illustrates an environmental view of the system releasably attached to the rear window of an automobile, according to an embodiment of the present invention;

FIG. 3 illustrates a block diagram of the control architecture for the system, according to an embodiment of the present invention; and

FIG. 4 illustrates a detailed view of the remote-control assembly of the system, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” _“top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

In general, the invention described herein relates to an automobile display system 10 for a variety of automobiles and may be used for both commercial and residential applications. The system 10 is configured to display a variety of inspirational, sympathetic, and uplifting messages to a trailing vehicle when the user (i.e., driver) depresses a desired message on a remote-control assembly 12 located a preferred location within the interior of the vehicle. It's is contemplated the remote-control assembly 12 will be affixed to an area of the dashboard readily accessible to the driver.

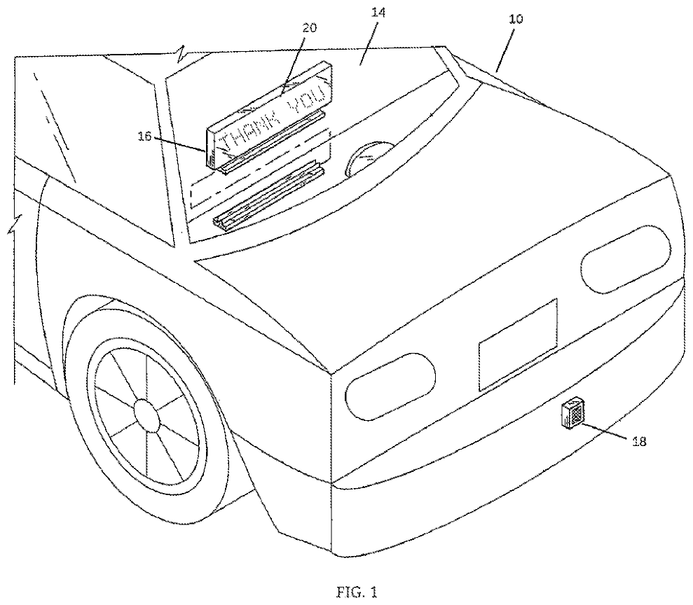

In reference to FIG. 1, the automobile display system 10 is illustrated in an embodiment of the invention releasably attached the rear window of the automobile 14. In the current embodiment, the system 10 is affixed to the rear window of the vehicle using an attachment means 16. Further shown in the current embodiment is a first proximity sensor 18 configured to be affixed to the rear of a vehicle and configured to detect a trailing vehicle at pre-determined range either by the characteristics of the infrared beam or the by software compensation. In the current embodiment, the proximity sensor 18 includes a predetermined range of 7 meters.

However, it is contemplated that the proximity sensor 18 may be adjusted to recognize a variety of ranges when a clear line of sight is provided by the user and attached to the vehicle. By deploying the at least one proximity sensor 18 to the vehicle the driver will be alerted when a trailing vehicle is sensed and may provide an inspiration message translucent display 20 or prevent a dangerous encounter from a driver experiencing “road rage.”

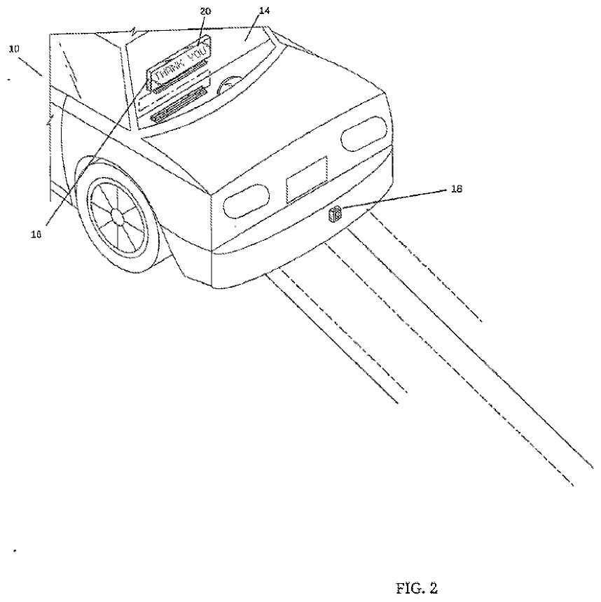

FIG. 2 illustrates an environmental view of the system 10 releasably attached to the rear window of the vehicle while in use. In this current embodiment, the driver has received notification that a trailing vehicle is within the predetermined distance and has selected a desired message from the plurality of stored messages within the memory module 24. Upon illumination of the translucent display 26 for a pre-selected period of time, the timing mechanism within the microprocessor 22 will extinguish the light emitting diodes.

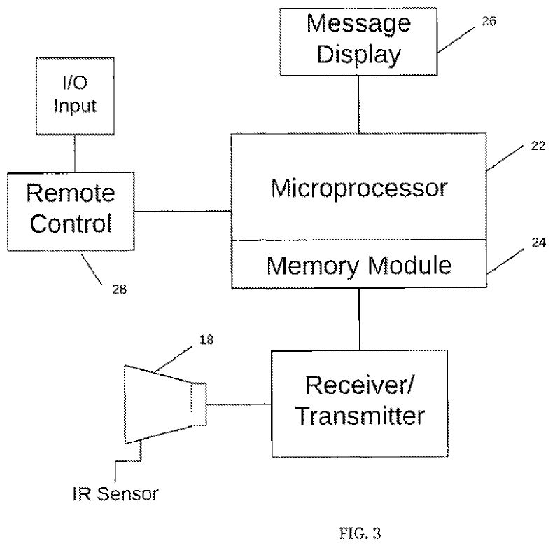

FIG. 3 illustrates a block diagram of the control architecture for the system 10 including the microprocessor 22 and integrated memory module 24 in electrical connection with both the translucent display 26 and remote-control assembly 28. The microprocessor 22 is configured to received input signal from the proximity sensor 18 and provide cause an electrical signal to the remote-control assembly 28 to notify the driver when a trailing vehicle is within the predetermined range. Further, the microprocessor 22 is configured to receive a signal from the remote-control assembly 28 and compare the signal with the plurality of pre-programmed message stored within the memory module 24.

When a desired message is selected by depressing the push-button indicator 30 on the remote-control assembly 28 the microprocessor will cause an output signal corresponding to the desired message to the translucent display 26. Further, when the microprocessor 22 determines that trailing vehicle is within the predetermined range of the vehicle, the microprocessor 22 will provide notification to the driver by illuminating a front side of the remote-control assembly 28.

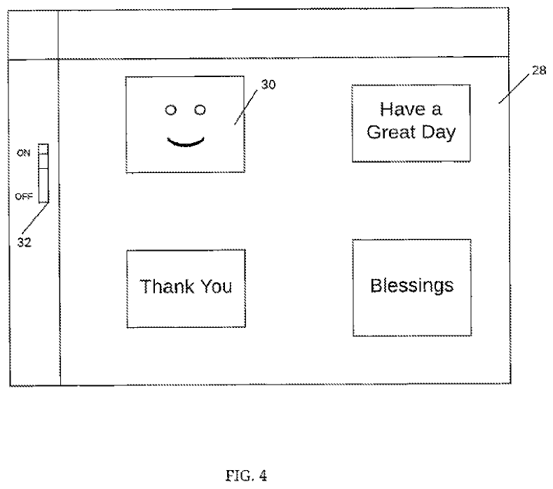

FIG. 4 illustrates a detailed view of the remote-control assembly 28 which includes an “on/off’ slide switch 32 to provide power to the assembly. While in use the driver may choose from the pre-selected messages shown on the face of the remote-control assembly 28 and select the preferred message by depressing the illuminated message. Once depressed, the message will illuminate for pre-selected period of time controlled by an internal timing mechanism of the microprocessor 22.

Many different embodiments have been disclosed herein. in connection with the above description and the drawings. It will be understood that it would be unduly repetitious and obfuscating to literally describe and illustrate every combination and sub combination of these embodiments. Accordingly, all embodiments can be combined in any way and/or combination, and the present specification, including the drawings, shall be construed to constitute a complete written description of all combinations and sub combinations of the embodiments described herein, and of the manner and process of making and using them, and shall support claims to any such combination or sub combination.

It will be appreciated by persons skilled in the art that the present embodiment is not limited to what has been particularly shown and described hereinabove. A variety of modifications and variations are possible in light of the above teachings without departing from the following claims.

What is claimed is:

1. A self-igniting assembly, the assembly comprising:
a microprocessor, the microprocessor having an integrated memory module;
the microprocessor being in electrical communication with a remote-control assembly and a display, and wherein the microprocessor being configured to provide a pre-programmed message to the display when selected at the remote-control assembly;
the remote-control assembly being affixed within an interior portion of an automobile, and wherein the remote-control assembly being configured with a plurality of pre-selected messages which when depressed causing an illuminated message on the display;
an infrared proximity sensor, the sensor being configured to provide an indication to the remote control when a trailing vehicle in a predetermined distance of the display; and
the display being releasably coupled to a desired position with an interior position of a rear-view window to provide a pre-selected message from a plurality of pre-programmed pre-selected messages in the memory module.

2. The assembly of claim 1, wherein the remote-control assembly further comprising:
a plurality of push-button indicators, wherein each of the plurality of push-button indicators being configured to correspond to at least one of the preselected message.

3. The assembly of claim 1, wherein the display being translucent.

4. The assembly of claim 3, wherein the translucent display being a light-emitting diode (LED).

5. The assembly of claim 4, wherein the LED being coupled along a first side of the display.

6. The assembly of claim 1, wherein the assembly further comprising:
A mounting means, the mounting beans to releasably couple the display to a portion of the rear-view window of the automobile.

7. The assembly of claim 1, wherein the assembly further comprising:
A transceiver, the transceiver configured to provide an electrical signal to the remote-control assembly indicating a trailing vehicle.

8. The assembly of claim 1, wherein the pre-determined message being “Have a Good Day”.

9. The assembly of claim 1, wherein the plurality of sensors being coupled to a rear of the automobile.
